(19) United States
(12) Patent Application Publication
(10) Pub. No.: US 2026/0313320 A1
(43) Pub. Date: Oct. 8, 2026

(54) UE MBS CONFIGURATION

(71) Applicant: Nokia Technologies Oy, Espoo (FI)

(72) Inventors: Bruno LANDAIS, Lannion (FR); Mohamed Amin NASSAR, Munich (DE); Horst Thomas BELLING, Munich (DE)

(21) Appl. No.: 19/482,997

(22) PCT Filed: May 7, 2024
(86) PCT No.: PCT/EP2024/062587

§ 371 Date: Nov. 10, 2025

(30) Foreign Application Priority Data
May 10, 2023 (GB) 2306871.1

(51) Int. Cl. H04W 4/06; H04W 4/021; H04W 48/04; H04W 88/06

(52) U.S. Cl. CPC H04W 4/06; H04W 4/021; H04W 48/04; H04W 88/06

(57) ABSTRACT

There are provided measures for (e.g. enabling/realizing enhancements and/or improvements for) UE MBS roaming configuration, i.e. UE configuration for multicastbroadcast service (MBS) for roaming. Such measures may exemplarily comprise that a user equipment (UE) receives UE configuration for multicast-broadcast service (MBS), said UE configuration comprising UE MBS roaming authorization information indicating an MBS service access authorization when roaming in a network other than its home network, and determines allowance or disallowance of MBS service access based on the UE MBS roaming authorization information when the UE is roaming in a network other than its home network.

### TECHNICAL FIELD

Various example embodiments generally relate to a wireless communication technique. More specifically, measures/mechanisms (including e.g. methods, apparatuses and computer program products) are described for enabling/realizing enhancements and/or improvements for UE MBS roaming configuration, i.e. UE configuration for multicast-broadcast service (MBS) for roaming.

### BACKGROUND

Various example embodiments relate to considerations in a (e.g. mobile/wireless) communication system or network, such as a 5G/NR system and a next-generation system beyond 5G. For example, various example embodiments are applicable in a 3GPP-standardized mobile/wireless communication system or network of Release 19 onwards.

Such considerations may relate to roaming (in its most general meaning), including when a UE e.g. is visiting or served by a public network, such as e.g. a PLMN, or is accessing or served by a non-public network, such as e.g. a SNPN or PNI-NPN, different from the UE's home network. Further, such considerations may relate to UE configuration for roaming.

### List of Acronyms and Abbreviations

3GPP 3rd Generation Partnership Project
5G Fifth Generation
ADF Application Dedicated File
ARFCN Absolute Radio Frequency Channel Number
DF Dedicated File
DNN Data Network Name
EF Elementary File
IP Internet Protocol
MBMS Multimedia Broadcast-Multicast Service
MBS Multicast-Broadcast Service.
MBSF Multicast-Broadcast Service Function.
MO Management Object
NFV Network Function Virtualisation
NFVI Network Function Virtualisation Infrastructure
NR New Radio
OMA Open Mobile Alliance
OTA Over-The-Air
PLMN Public Land Mobile Network
PNI-NPN Public Network Integrated Non-Public Network
SDN Software-Defined Networking
SNPN Standalone Non-Public Network
SSM Source Specific (IP) Multicast address.
S-NSSAI Single Network Slice Selection Assistance Information
TLV Tag-Length-Value
TMGI Temporary Mobile Group Identity
UE User Equipment
UICC Universal Integrated Circuit Card
USD User Service Description
USIM Universal Subscriber Identity Module

### SUMMARY

Various example embodiments address at least part of issues, problems and/or drawbacks described herein or recognized by a person skilled in the art.

Various example embodiments are set out in the claims.

According to an example aspect, there is provided a method, comprising: receiving, by a user equipment (UE), UE configuration for multicast-broadcast service (MBS), said UE configuration comprising UE MBS roaming authorization information indicating an MBS service access authorization when roaming in a network other than its home network, and determining, by the user equipment (UE), allowance or disallowance of MBS service access based on the UE MBS roaming authorization information when the UE is roaming in a network other than its home network.

According to an example aspect, there is provided an apparatus, comprising: means for receiving, by a user equipment (UE), UE configuration for multicast-broadcast service (MBS), said UE configuration comprising UE MBS roaming authorization information indicating an MBS service access authorization when roaming in a network other than its home network, and means for determining, by the user equipment (UE), allowance or disallowance of MBS service access based on the UE MBS roaming authorization information when the UE is roaming in a network other than its home network.

According to an example aspect, there is provided an apparatus, comprising at least one processor, and at least one memory storing instructions that, when executed by the at least one processor, cause the apparatus at least to: receive, by a user equipment (UE), UE configuration for multicast-broadcast service (MBS), said UE configuration comprising UE MBS roaming authorization information indicating an MBS service access authorization when roaming in a network other than its home network, and determine, by the user equipment (UE), allowance or disallowance of MBS service access based on the UE MBS roaming authorization information when the UE is roaming in a network other than its home network.

According to an example aspect, there is provided an apparatus, comprising: circuitry configured to receive, by a user equipment (UE), UE configuration for multicast-broadcast service (MBS), said UE configuration comprising UE MBS roaming authorization information indicating an MBS service access authorization when roaming in a network other than its home network, and circuitry configured to determine, by the user equipment (UE), allowance or disallowance of MBS service access based on the UE MBS roaming authorization information when the UE is roaming in a network other than its home network.

According to various developments/modifications, any one of the aforementioned method-related and/or apparatus-related example aspects may include one or more of the following features:
said UE MBS roaming authorization information comprises roaming-related information about whether the UE is allowed or disallowed to access MBS services when roaming,
said roaming-related information relates to or is related to at least one of the following: an MBS service type and a network in which the UE is roaming,
the MBS service type comprises or relates to multicast and broadcast MBS services, multicast MBS services or broadcast MBS services,
the network in which the UE is roaming comprises or relates to a public network, such as a public land mobile network, or a non-public network, such as a standalone non-public network or a public network integrated non-public network,
said roaming-related information identifies or indicates at least one of the following: the MBS service type; the network and/or a type of the network,
said UE MBS roaming authorization information comprises network-related information about one or more networks in which the UE is allowed or disallowed to access MBS services when roaming in said one or more networks,
said network-related information identifies or indicates said one or more networks, or said one or more networks and an MBS service type,
the MBS service type comprises or relates to multicast and broadcast MBS services, multicast MBS services or broadcast MBS services,
said UE MBS roaming authorization information comprises service-related information about one or more MBS services which the UE is allowed or disallowed to access when roaming,
said service-related information identifies or indicates said one or more MBS services, or said one or more MBS services and one or more networks in which the UE is allowed or disallowed to access said one or more MBS services when roaming in said one or more networks,
in said service-related information, an MBS service is identified or indicated by a temporary mobile group identifier or a source-specific IP multicast address,
the method, functionality, operability or configuration comprises or enables: performing control in accordance with determination of allowance or disallowance of MBS service access,
said UE configuration comprises UE MBS configuration information indicating an MBS service access configuration,
the method, functionality, operability or configuration comprises or enables: initiating, by the user equipment (UE), accessing an MBS service in a network based on the UE MBS configuration information after determining allowance to access the MBS service based on the UE MBS roaming authorization information, said MBS service and the network in which the UE is roaming, when the UE is roaming in the network which is a network other than its home network,
the method, functionality, operability or configuration comprises or enables: inhibiting, by the user equipment (UE), accessing an MBS service in a network based on the UE MBS configuration information after determining disallowance to access the MBS service based on the UE MBS roaming authorization information, said MBS service and the network in which the UE is roaming, when the UE is roaming in the network which is a network other than its home network,
said UE configuration is included, provided or defined in a multicast-broadcast UE pre-configuration Management Object (MO),
said UE MBS roaming authorization information is included, provided or defined as or in at least one of the following: at least one dedicated roaming authorization node in said multicast-broadcast UE pre-configuration MO, or at least one per-network configuration node in said multicast-broadcast UE pre-configuration MO,
a dedicated roaming authorization node includes, provides or defines at least roaming-related information of said UE MBS roaming authorization information,
a dedicated roaming authorization node and/or a per-network configuration node includes, provides or defines at least network-related information and/or service-related information of said UE MBS roaming authorization information,
a dedicated service access leaf in a per-network configuration node includes, provides or defines service-related information of said UE MBS roaming authorization information,
said UE configuration is included, provided or defined in a Universal Subscriber Identity Module (USIM) or a USIM application on a Universal Integrated Circuit Card (UICC) or a file of a USIM application,
said UE MBS roaming authorization information is included, provided or defined as or in at least one configuration data object in said USIM or USIM application or file of USIM application,
any one of said roaming-related information of said UE MBS roaming authorization information, said network-related information of said UE MBS roaming authorization information and said service-related information of said UE MBS roaming authorization information is included, provided or defined in or by at least one tag-length-value element in said at least one configuration data object,
said at least one configuration data object comprises one or more of: at least one tag-length-value element which includes, provides or defines said roaming-related information of said UE MBS roaming authorization information, at least one tag-length-value element which includes, provides or defines said network-related information of said UE MBS roaming authorization information, at least one tag-length-value element which includes, provides or defines said service-related information of said UE MBS roaming authorization information,
said UE configuration is or comprises UE pre-configuration for multicast-broadcast service,
roaming comprises that the UE is visiting or served by a public network, such as a public land mobile network, or the UE is accessing or served by a non-public network, such as a standalone non-public network or a public network integrated non-public network,
the network other than its home network, when the UE is roaming, is or comprises a public network, such as a public land mobile network, or a non-public network, such as a standalone non-public network or a public network integrated non-public network.

According to an example aspect, there is provided a method, comprising: obtaining, by a network or operator entity, UE configuration for multicast-broadcast service (MBS) for a user equipment (UE), said UE configuration comprising UE MBS roaming authorization information indicating an MBS service access authorization when roaming in a network other than its home network, and providing, by the network or operator entity, said UE configuration for multicast-broadcast service (MBS) to said user equipment (UE).

According to an example aspect, there is provided an apparatus, comprising: means for obtaining, by a network or operator entity, UE configuration for multicast-broadcast service (MBS) for a user equipment (UE), said UE configuration comprising UE MBS roaming authorization information indicating an MBS service access authorization when roaming in a network other than its home network, and means for providing, by the network or operator entity, said UE configuration for multicast-broadcast service (MBS) to said user equipment (UE).

According to an example aspect, there is provided an apparatus, comprising at least one processor, and at least one memory storing instructions that, when executed by the at least one processor, cause the apparatus at least to: obtain, by a network or operator entity, UE configuration for multicast-broadcast service (MBS) for a user equipment (UE), said UE configuration comprising UE MBS roaming authorization information indicating an MBS service access authorization when roaming in a network other than its home network, and provide, by the network or operator entity, said UE configuration for multicast-broadcast service (MBS) to said user equipment (UE).

According to an example aspect, there is provided an apparatus, comprising: circuitry configured to obtain, by a network or operator entity, UE configuration for multicast-broadcast service (MBS) for a user equipment (UE), said UE configuration comprising UE MBS roaming authorization information indicating an MBS service access authorization when roaming in a network other than its home network, and circuitry configured to provide, by the network or operator entity, said UE configuration for multicast-broadcast service (MBS) to said user equipment (UE).

According to various developments/modifications, any one of the aforementioned method-related and/or apparatus-related example aspects may include one or more of the following features:
said UE MBS roaming authorization information comprises roaming-related information about whether the UE is allowed or disallowed to access MBS services when roaming,
said roaming-related information relates to or is related to at least one of the following: an MBS service type and a network in which the UE is roaming,
the MBS service type comprises or relates to multicast and broadcast MBS services, multicast MBS services or broadcast MBS services,
the network in which the UE is roaming comprises or relates to a public network, such as a public land mobile network, or a non-public network, such as a standalone non-public network or a public network integrated non-public network,
said roaming-related information identifies or indicates the MBS service type, and/or the network and/or a type of the network,
said UE MBS roaming authorization information comprises: network-related information about one or more networks in which the UE is allowed or disallowed to access MBS services when roaming in said one or more networks,
said network-related information identifies or indicates said one or more networks, or said one or more networks and an MBS service type,
the MBS service type comprises or relates to multicast and broadcast MBS services, multicast MBS services or broadcast MBS services,
said UE MBS roaming authorization information comprises service-related information about one or more MBS services which the UE is allowed or disallowed to access when roaming,
said service-related information identifies or indicates said one or more MBS services, or said one or more MBS services and one or more networks in which the UE is allowed or disallowed to access said one or more MBS services when roaming in said one or more networks,
in said service-related information, an MBS service is identified or indicated by a temporary mobile group identifier or a source-specific IP multicast address,
said UE configuration comprises UE MBS configuration information indicating an MBS service access configuration,
said obtaining comprises: establishing, by an operator entity, said UE configuration, or receiving, by a network entity, said UE configuration,
said UE configuration is included, provided or defined in a multicast-broadcast UE pre-configuration Management Object (MO),
said UE MBS roaming authorization information is included, provided or defined as or in at least one dedicated roaming authorization node in said multicast-broadcast UE pre-configuration MO, and/or at least one per-network configuration node in said multicast-broadcast UE pre-configuration MO,
a dedicated roaming authorization node includes, provides or defines at least roaming-related information of said UE MBS roaming authorization information,
a dedicated roaming authorization node and/or a per-network configuration node includes, provides or defines at least network-related information and/or service-related information of said UE MBS roaming authorization information,
a dedicated service access leaf in a per-network configuration node includes, provides or defines service-related information of said UE MBS roaming authorization information,
said providing comprises transmitting or programming said multicast-broadcast UE pre-configuration MO to said UE,
said UE configuration is included, provided or defined in a Universal Subscriber Identity Module (USIM) or a USIM application on a Universal Integrated Circuit Card (UICC) or a file of a USIM application,
said UE MBS roaming authorization information is included, provided or defined as or in at least one configuration data object in said USIM or USIM application or file of USIM application,
any one of said roaming-related information of said UE MBS roaming authorization information, said network-related information of said UE MBS roaming authorization information and said service-related information of said UE MBS roaming authorization information is included, provided or defined in or by at least one tag-length-value element in said at least one configuration data object,
said at least one pre-configuration data object comprises one or more of: at least one tag-length-value element which includes, provides or defines said roaming-related information of said UE MBS roaming authorization information, at least one tag-length-value element which includes, provides or defines said network-related information of said UE MBS roaming authorization information, at least one tag-length-value element which includes, provides or defines said service-related information of said UE MBS roaming authorization information,
said providing comprises delivering said USIM or UICC to a user of the user equipment for introducing into the UE,
said UE configuration is or comprises UE pre-configuration for multicast-broadcast service,
roaming comprises that the UE is visiting or served by a public network, such as a public land mobile network, or the UE is accessing or served by a non-public network, such as a standalone non-public network or a public network integrated non-public network,
the network other than its home network, when the UE is roaming, is or comprises a public network, such as a public land mobile network, or a non-public network, such as a standalone non-public network or a public network integrated non-public network.

According to an example aspect, there is provided a system comprising at least two of the apparatuses according to any one of the aforementioned apparatus-related example aspects (and/or any development/modification thereof).

According to an example aspect, there is provided a computer-readable medium comprising program instructions for causing an apparatus (e.g. an apparatus according to any one of the aforementioned apparatus-related example aspects (and/or any development/modification thereof)) to perform at least a method according to any one of the aforementioned method-related example aspects (and/or any development/modification thereof).

According to an example aspect, there is provided a computer program product comprising (computer-executable) computer program code which, when the program code is executed (or run) on a computer or the program is run on a computer (e.g. a computer of an apparatus according to any one of the aforementioned apparatus-related example aspects (and/or any development/modification thereof)), is configured to cause the computer to carry out at least a method according to any one of the aforementioned method-related example aspects (and/or any development/modification thereof).

The computer program product may comprise or may be embodied as a (tangible/non-transitory) computer-readable (storage) medium or the like, on which the computer-executable computer program code is stored, and/or the program is directly loadable into an internal memory of the computer or a processor thereof.

The term “non-transitory,” as used herein, is a limitation of the medium itself (referring to e.g. a tangible medium, not a signal) as opposed to a limitation on data storage persistency (e.g. RAM vs. ROM).

Further developments and/or modifications of the aforementioned example aspects are set out in the following.

By way of example embodiments, a technique for (e.g. enabling/realizing enhancements and/or improvements for) UE MBS roaming configuration, i.e. UE configuration for multicast-broadcast service (MBS) for roaming, may be provided.

This summary is intended to provide a brief overview of some of the aspects and features according to the present disclosure. Accordingly, it will be appreciated that the above-described aspects and features are merely examples and should not be construed to narrow the scope of the present disclosure in any way. Other features, aspects, and advantages of the present disclosure will become apparent from the following detailed description, drawings and claims.

### BRIEF DESCRIPTION OF THE DRAWINGS

In the following, various example embodiments will be described with reference to the accompanying drawings, in which

FIG. 1 shows a schematic diagram of an example (mobile/wireless) communication system or network;

FIG. 2 shows a schematic diagram of an example wireless device or entity;

FIG. 3 shows a schematic diagram of an example network node or entity;

FIG. 4 shows a flowchart of a method or process at/by an apparatus according to at least one example embodiment;

FIG. 5 shows a flowchart of a method or process at/by an apparatus according to at least one example embodiment;

FIG. 6 shows a schematic diagram of an example of UE MBS configuration according to at least one example embodiment;

FIG. 7 shows a schematic diagram of an example structure of/for UE MBS configuration according to at least one example embodiment;

FIG. 8 shows a schematic diagram of an example structure of/for at least part of UE MBS roaming authorization information according to at least one example embodiment;

FIG. 9 shows a schematic diagram of an example structure of/for at least part of UE MBS configuration information according to at least one example embodiment;

FIG. 10 shows a schematic diagram of an example structure of/for at least part of UE MBS roaming authorization information according to at least one example embodiment;

FIG. 11 shows a schematic diagram of an example structure of/for at least part of UE MBS roaming authorization information according to at least one example embodiment;

FIG. 12 shows a schematic diagram of an example structure of/for UE MBS configuration according to at least one example embodiment;

FIG. 13 shows a schematic diagram of an example structure of/for at least part of UE MBS roaming authorization information and at least part of UE MBS configuration information according to at least one example embodiment; and

FIG. 14 shows a schematic block diagram illustrating a structure of apparatuses according to at least one example embodiment.

### DETAILED DESCRIPTION

Various example embodiments are herein described with reference to particular non-limiting and illustrative examples. A person skilled in the art will appreciate that these various example embodiments are by no means limited to these non-limiting and illustrative examples, and may be more broadly applied.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It is to be noted that the detailed description, at times, refers to one or more specifications being used as non-limiting and illustrative examples for certain architectures, network configurations and system deployments. More specifically, the detailed description makes reference to 3GPP standards, being used as non-limiting and illustrative examples. As such, the example embodiments provided herein can specifically employ terminology which is directly related thereto. Such terminology is only used in the context of the non-limiting and illustrative examples, and is not intended to limit the example embodiments in any way. Rather, any other system configuration or deployment may be utilized while complying with what is described herein and/or example embodiments are applicable to it.

For example, various example embodiments are applicable in any (e.g., mobile/wireless) communication system, such as a 5G/NR system and a next-generation system beyond 5G. For example, various example embodiments are applicable in a 3GPP-standardized mobile/wireless communication system of Release 19 onwards.

Hereinafter, various example embodiments are described using several variants and/or alternatives. It is generally to be noted that, according to certain implementations or constraints, all of the described variants and/or alternatives may be provided alone or in any conceivable combination (e.g. also including combinations of individual features of these various variants and/or alternatives).

As used herein, the words “comprising” and “including” should be understood as not limiting the example embodiments to consist of only those features that have been mentioned, and example embodiments may also contain, among other things, e.g. features, structures, units, modules, or the like, that have not been specifically mentioned.

As used herein, “at least one of the following: <a list of two or more elements>” and “at least one of <a list of two or more elements>” and similar wording, like “one or more of”, where the list of two or more elements are joined by “and” or “or”, mean at least any one of the elements, or at least any two or more of the elements, or at least all the elements.

As used herein, according to various example embodiments, any operations of sending or receiving may comprise actual transmission or communication operations, i.e. transmitting or communicating associated messages or signals, but may additionally or alternatively comprise related processing operations, i.e. preparing/generating/issuing associated messages or signals before sending and/or obtaining/handling/processing of associated messages or signals after receiving. For example, sending a message at/by an entity may comprise generating/issuing and/or transmitting/communicating thereof or a corresponding signal in/at/by the entity, and receiving a message at/by an entity may comprise obtaining/handling and/or processing thereof or a corresponding signal in/at/by the entity. As used herein, a message may refer to and/or encompass any kind of corresponding information, signal or the like.

In the drawings, it is to be noted that lines/arrows interconnecting individual blocks or entities are generally meant to illustrate an operational coupling there-between, which may be a physical and/or logical coupling, which on the one hand is implementation-independent (e.g. wired or wireless) and on the other hand may also comprise an arbitrary number of intermediary functional blocks or entities not shown. In flowcharts or sequence diagrams, the illustrated order of operations or actions is generally non-limiting and illustrative, and any other order of respective operations or actions is conceivable, if feasible.

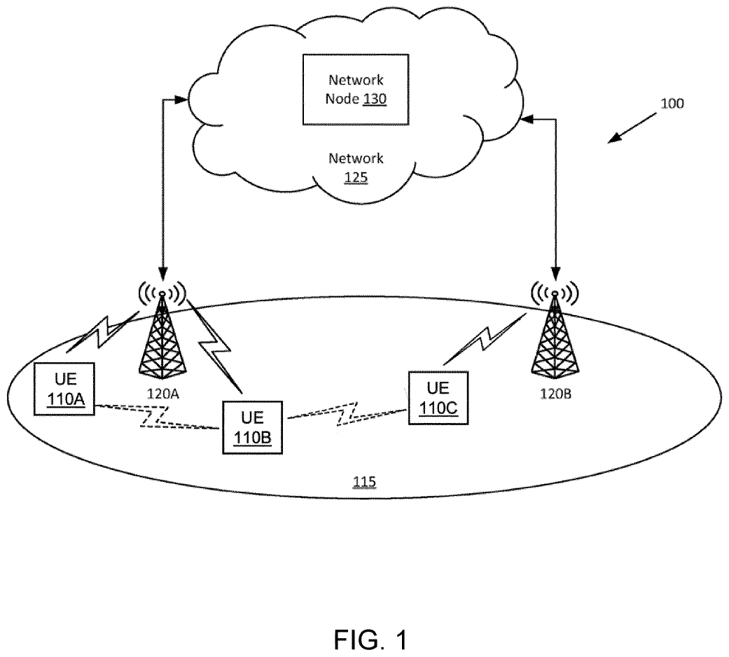

Before explaining example embodiments in detail, certain general principles of a (mobile/wireless) communication system or network are briefly explained with reference to FIGS. 1 to 3 to assist in understanding the technology underlying the described example embodiments.

FIG. 1 illustrates an example of a (mobile/wireless) communication system or network 100 that may be used for wireless communications. Communication system or network 100 includes wireless devices or entities, such as UEs 110 (e.g., 110A-110C), and network nodes or entities, such as radio access nodes 120 (e.g., 120A-120B) (e.g., eNBs, gNBs, etc.), connected to one or more network nodes or entities 130 via an interconnecting network 125. Communication system or network 100 may use any suitable deployment scenarios. UEs 110 within coverage area 115 may each be capable of communicating directly with radio access nodes 120 over a wireless interface. In some embodiments, UEs 110 may also be capable of communicating with each other via D2D communication.

As an example, UE 110A may communicate with radio access node 120A over a wireless interface. That is, UE 110A may transmit wireless signals to and/or receive wireless signals from radio access node 120A. The wireless signals may contain voice traffic, data traffic, control signals, and/or any other suitable information.

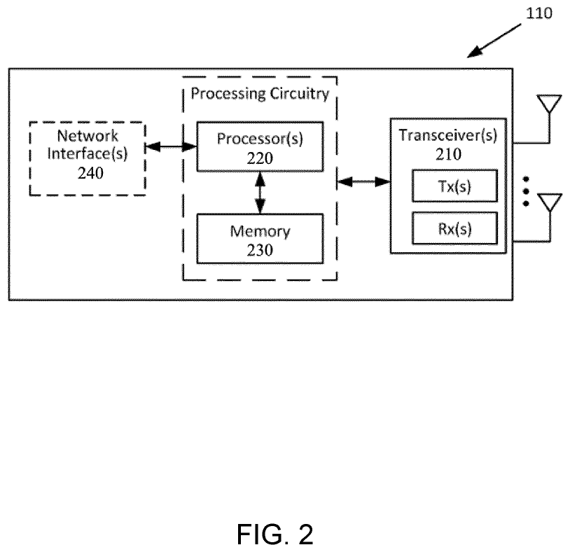

As used herein, the term “user equipment” (UE) has the full breadth of its ordinary meaning and may refer to any type of wireless device or entity which can communicate with a network node or entity and/or with another UE in a cellular or mobile or wireless/mobile communication system. Examples of UE are target device, D2D UE, machine type UE or UE capable of machine-to-machine (M2M) communication, personal digital assistant, tablet, mobile terminal, smartphone, laptop embedded equipped (LEE), laptop mounted equipment (LME), USB dongles, ProSe UE, vehicle-to-vehicle (V2V) UE, V2X UE, MTC UE, eMTC UE, FeMTC UE, UE Cat 0, UE Cat Ml, narrow band IoT (NB-IoT) UE, UE Cat NB1, etc. Example embodiments of a UE are described in more detail below with respect to FIG. 2.

In some embodiments, an area of wireless signal coverage 115 associated with a radio access node 120 may be referred to as a cell. However, particularly with respect to the fifth generation (5G)/New Radio (NR) mobile communication concepts, beams may be used instead of cells and, as such, it is important to note that concepts described herein are equally applicable to both cells and beams.

With respect to a beam-based mobile communication system, the radio access node 120 (base station) may transmit a beamformed signal to the UE 110 in one or more transmit directions (transmission beam, Tx beam). The UE 110 may receive the beamformed signal from the base station 120 in one or more receive directions (reception beam, Rx beam). The UE 110 may also transmit a beamformed signal to the base station 120 in one or more directions and the base station 120 may receive the beamformed signal from the UE 110 in one or more directions. The base station 120 and the UE 110 may determine the best receive and transmit directions, e.g., best in the sense of these directions leading to the highest link quality or fulfilling other quality conditions in the most suitable manner, for each of the base station/UE pairs.

The interconnecting network 125 may refer to any interconnecting system capable of transmitting audio, video, signals, data, messages, etc., or any combination of the preceding. The interconnecting network 125 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, the network node 130 may be a core network node, managing the establishment of communication sessions and other various other functionalities for UEs 110. Examples of network node 130 may include mobile switching center (MSC), MME, serving gateway (SGW), packet data network gateway (PGW), operation and maintenance (O&M), operations support system (OSS), SON, positioning node (e.g., Enhanced Serving Mobile Location Center, E-SMLC), location server node, MDT node, etc. UEs 110 may exchange certain signals with the network node 130 using the non-access stratum (NAS) layer. In non-access stratum signaling, signals between UEs 110 and the network node 130 may be transparently passed through the radio access network. In some embodiments, radio access nodes 120 may interface with one or more network nodes 130 over an internode interface.

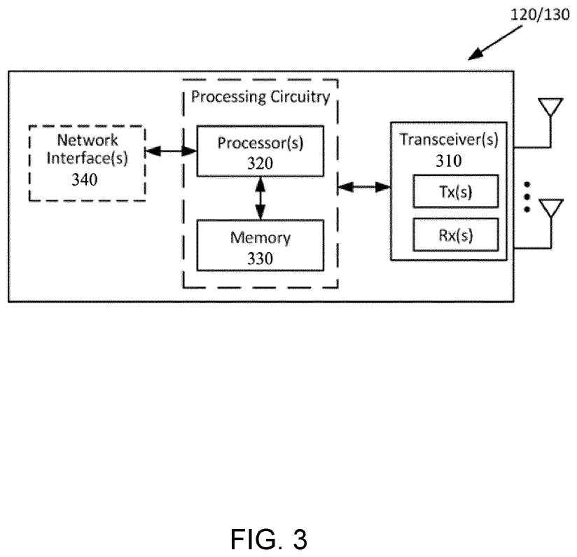

As used herein, the term “network node or entity” has the full breadth of its ordinary meaning and may correspond to any type of radio access node (or radio network node) or any network node, which can communicate with a UE and/or with another network node in a cellular or mobile or wireless communication system. Examples of network nodes are NodeB, MeNB, SeNB, a network node may belonging to MCG or SCG, base station (BS), multi-standard radio (MSR) radio access node such as MSR BS, eNodeB, network controller, radio network controller (RNC), base station controller (BSC), relay, donor node controlling relay, base transceiver station (BTS), access point (AP), transmission point, transmission node, RRU, RRH, node in distributed antenna system (DAS), core network node (e.g., MSC, MME, etc.), O&M, OSS, Self-organizing Network (SON), positioning node (e.g., E-SMLC), MDT, test equipment, etc. Example embodiments of a network node are described in more detail below with respect to FIG. 3.

In some embodiments, radio access node 120 may be a distributed radio access node. The components of the radio access node 120, and their associated functions, may be separated into two main units (or sub-radio network nodes) which may be referred to as the central unit (CU) and the distributed unit (DU). Different distributed radio network node architectures are possible. For instance, in some architectures, a DU may be connected to a CU via dedicated wired or wireless link (e.g., an optical fiber cable) while in other architectures, a DU may be connected a CU via a transport network. Also, how the various functions of the radio access node 120 are separated between the CU(s) and DU(s) may vary depending on the chosen architecture.

Exemplary wireless communication systems are architectures standardized by the 3rd Generation Partnership Project (3GPP). A latest 3GPP based development is often referred to as the long-term evolution (LTE) of the Universal Mobile Telecommunications System (UMTS) radio-access technology (RAT). The various development stages of the 3GPP specifications are referred to as releases. More recent developments of the LTE are often referred to as LTE Advanced (LTE-A). The LTE (LTE-A) employs a radio mobile architecture known as the Evolved Universal Terrestrial Radio Access Network (E-UTRAN) and a core network known as the Evolved Packet Core (EPC). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other RAT examples comprise those provided by base stations of systems that are based on technologies such as WLAN and/or Worldwide Interoperability for Microwave Access (WiMax). A base station can provide coverage for an entire cell or similar radio service area. Core network elements include Mobility Management Entity (MME), Serving Gateway (S-GW) and Packet Gateway (P-GW).

An example of a suitable communications system is the 5G or NR concept. Network architecture in NR may be similar to that of LTE-A. Base stations of NR systems may be known as next generation Node Bs (gNBs). Changes to the network architecture may depend on the need to support various radio technologies and finer Quality of Service (QoS) support, and some on-demand requirements for QoS levels to support Quality of Experience (QoE) of user point of view. Also network aware services and applications, and service and application aware networks may bring changes to the architecture. Those are related to Information Centric Network (ICN) and User-Centric Content Delivery Network (UC-CDN) approaches. NR may use multiple input-multiple output (MIMO) antennas, many more base stations or nodes than the LTE (a so-called small cell concept), including macro sites operating in cooperation with smaller stations and perhaps also employing a variety of radio technologies for better coverage and enhanced data rates.

Future networks may utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes, or hosts. It should also be understood that the distribution of labor between core network operations and base station operations may differ from that of the LTE or even be non-existent.

An example 5G core network (CN) comprises functional entities. The CN is connected to a UE via the radio access network (RAN). An UPF (User Plane Function) whose role is called PSA (PDU Session Anchor) may be responsible for forwarding frames back and forth between the DN (data network) and the tunnels established over the 5G towards the UEs exchanging traffic with the data network (DN). The UPF is controlled by an SMF (Session Management Function) that receives policies from a PCF (Policy Control Function). The CN may also include an AMF (Access & Mobility Function).

Generally, all concepts disclosed herein may be applicable to different communication networks, comprising but not limited to LTE, LTE-A, 5G, 5G advanced, 6G, and other future or already implemented networks.

FIG. 2 is a schematic diagram of an example wireless device, UE 110, according certain example embodiments. UE 110 may include one or more of at least one transceiver 210, at least one processor 220, at least one memory 230, and at least one network interface 240. In certain example embodiments, the transceiver 210 facilitates transmitting wireless signals to and receiving wireless signals from radio access node 120 (e.g., via transmitter(s) (Tx), receiver(s) (Rx) and antenna(s)). The processor 220 executes instructions to provide some or all of the functionalities described herein as being provided by a wireless device/entity or UE, and the memory 230 stores the instructions executed by the processor 220. In some embodiments, the processor 220 and the memory 230 form processing circuitry.

The processor 220 may include any suitable combination of hardware to execute instructions and manipulate data to perform some or all of the described functions of a wireless device or entity, such as the functions of UE 110 described herein. In some embodiments, the processor 220 may include, for example, one or more computers, one or more central processing units (CPUs), one or more microprocessors, one or more application specific integrated circuits (ASICs), one or more field programmable gate arrays (FPGAs) and/or other logic.

The memory 230 is generally operable to store instructions, such as a computer program, software, an application including one or more of logic, rules, algorithms, code, tables, etc. and/or other instructions capable of being executed by a processor 220. Examples of memory 230 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information, data, and/or instructions that may be used by the processor 220 of UE 110. For example, the memory 230 includes computer program code causing the processor 220 to perform processing according to any corresponding methods described herein.

The network interface 240 is communicatively coupled to the processor 220 and may refer to any suitable device operable to receive input for UE 110, send output from UE 110, perform suitable processing of the input or output or both, communicate to other devices, or any combination thereof. The network interface 240 may include appropriate hardware (e.g., port, modem, network interface card, etc.) and software, including protocol conversion and data processing capabilities, to communicate through a network.

Other embodiments of UE 110 may include additional components beyond those shown in FIG. 2 that may be responsible for providing certain aspects of the wireless device's functionalities, including any of the functionalities described herein and/or any additional functionalities (including any functionality necessary to support the mechanisms according to the subject disclosure). As an example, UE 110 may include input devices and circuits, output devices, and one or more synchronization units or circuits, which may be part of the processor 220. Input devices include mechanisms for entry of data into UE 110. For example, input devices may include input mechanisms, such as a microphone, input elements, a display, etc. Output devices may include mechanisms for outputting data in audio, video and/or hard copy format. For example, output devices may include a speaker, a display, etc.

In certain example embodiments, the wireless device UE 110 may comprise a series of modules configured to implement the functionalities of the wireless device described herein.

It will be appreciated that the various modules may be implemented as combination of hardware and software, for instance, the processor, memory, and transceiver(s) of UE 110 shown in FIG. 2. Certain example embodiments may also include additional modules to support additional and/or optional functionalities.

FIG. 3 is a schematic diagram of an example radio access node 120 or network node or entity 130 according to certain example embodiments. Radio access node 120 or network node or entity 130 may include one or more of at least one transceiver 310, at least one processor 320, at least one memory 330, and at least one network interface 340. In certain example embodiments, the transceiver 310 facilitates transmitting wireless signals to and receiving wireless signals from wireless devices, such as UE 110 (e.g., via transmitter(s) (Tx), receiver(s) (Rx), and antenna(s)). The processor 320 executes instructions to provide some or all of the functionalities described herein as being provided by the radio access node 120 or the network node or entity 130, the memory 330 stores the instructions executed by the processor 320. In some embodiments, the processor 320 and the memory 330 form processing circuitry. The network interface 340 can communicate signals to backend network components, such as a gateway, switch, router, Internet, Public Switched Telephone Network (PSTN), core network nodes or radio network controllers, etc.

The processor 320 can include any suitable combination of hardware to execute instructions and manipulate data to perform some or all of the described functions of the radio access node 120 or the network node or entity 130, such as those described herein. In some embodiments, the processor 320 may include, for example, one or more computers, one or more central processing units (CPUs), one or more microprocessors, one or more application specific integrated circuits (ASICs), one or more field programmable gate arrays (FPGAs) and/or other logic.

The memory 330 is generally operable to store instructions, such as a computer program, software, an application including one or more of logic, rules, algorithms, code, tables, etc. and/or other instructions capable of being executed by a processor 320. Examples of memory 330 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information. For example, the memory 330 includes computer program code causing the processor 320 to perform processing according to any corresponding methods described herein.

In certain example embodiments, the network interface 340 is communicatively coupled to the processor 320 and may refer to any suitable device operable to receive input for the radio access node 120 or the network node or entity 130, send output from the radio access node 120 or the network node or entity 130, perform suitable processing of the input or output or both, communicate to other devices, or any combination of the preceding. The network interface 340 may include appropriate hardware (e.g., port, modem, network interface card, etc.) and software, including protocol conversion and data processing capabilities, to communicate through a network.

Other example embodiments of the radio access node 120 or the network node or entity 130 can include additional components beyond those shown in FIG. 3 that may be responsible for providing certain aspects of the node's functionalities, including any of the functionalities described herein and/or any additional functionalities (including any functionality necessary to support the solutions described herein). The various different types of radio access nodes or network nodes may include components having the same physical hardware but configured (e.g., via programming) to support different radio access technologies, or may represent partly or entirely different physical components.

Processors, interfaces, and memory similar to those described with respect to FIG. 3 may be included in other nodes or entities (such as UE 110, radio access node 120, etc.). Other nodes or entities may optionally include or not include a wireless interface (such as the transceiver described in FIG. 3).

In certain example embodiments, the radio access node 120 or the network node or entity 130 may comprise a series of modules configured to implement the functionalities of the radio access node 120 or the network node or entity 130 described herein.

It will be appreciated that the various modules may be implemented as combination of hardware and software, for instance, the processor, memory, and transceiver(s) of the radio access node 120 or the network node or entity 130 shown in FIG. 3. Certain example embodiments may also include additional modules to support additional and/or optional functionalities.

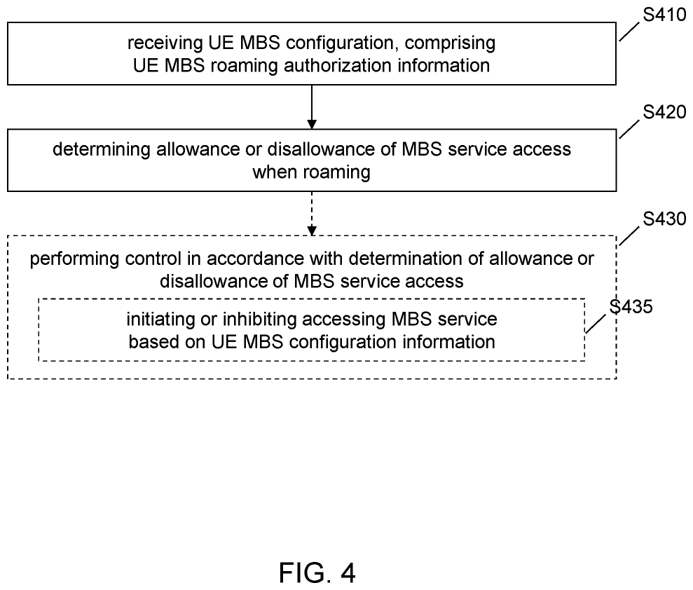

Before referring to FIGS. 4 to 14 and describing specifics of a technique for (e.g. enabling/realizing enhancements and/or improvements for) UE MBS roaming configuration, i.e. UE configuration for multicast-broadcast service (MBS) for roaming, some background information and aspects related to example embodiments will be provided. It should be noted that all concepts described herein, although described in a specific manner or context, may be more generally applicable, e.g. in another specific manner or context, as will be apparent to the skilled person.

Herein, reference is made to multicast-broadcast service (MBS). A multicast-broadcast service (MBS) can be understood as or encompass at least one of multicast service, broadcast service and multicast and broadcast service. A multicast-broadcast service (MBS) is an example of a point-to-multipoint communication service in which data is transmitted from a single source/transmitter device or entity to multiple target/recipient devices or entities, which may be all devices or entities, i.e. all users, in a broadcast service area (in the case of a broadcast service such as e.g. a broadcast MBS service) or devices or entities, i.e. users, in a multicast group (in the case of a multicast service such as e.g. a multicast MBS service). Accordingly, the present disclosure is generally applicable for any point-to-multipoint communication service. Such point-to-multipoint communication service may also be or comprise a Multimedia Broadcast-Multicast Service (MBMS), or the like.

Herein, reference is made to roaming. The term “roaming” is to be construed in its most general meaning, referring to any case, situation or environment in which a UE is not located, operated, served or handled in its home network but in another network, i.e. a network other than its home network. A UE's home network may be a public network, such as e.g. a PLMN, and the another network may be a public network, such as e.g. a PLMN, a non-public network, such as e.g. a SNPN or PNI-NPN. Roaming may comprise that a UE is visiting or served by a public network, such as a public land mobile network, different from the UE's home network, or a UE is accessing or served by a non-public network, such as a standalone non-public network or a public network integrated non-public network, different from the UE's home network.

Herein, reference is made to UE configuration. A configuration of a UE may be or comprise a pre-configuration and/or a recent/online/real-time configuration. Hence, UE configuration encompasses that a UE is provided with (part of a) configuration in advance and/or (part of a) configuration on-the-fly. Further, a configuration may be or comprise an initial configuration and/or a later re-/configuration such as an update (e.g. an OTA update). Hence, UE configuration encompasses that a UE is firstly provided with (part of a) configuration for establishing or setting the configuration and/or is subsequently/again provided with (part of a) configuration for updating or changing the configuration. A configuration may refer to any kind of data, information, parameters, etc. the UE can use for the corresponding purpose, such as e.g. accessing an MBS service.

Example embodiments, as described herein, are implementation/architecture-independent. In the example case of 5G multicast-broadcast services, architectural considerations and/or provisions as specified in 3GPP TS 23.247 V17.6.0 or V18.1.0 can be adopted.

In 3GPP standardization (Rel-17 and Rel-18), multicast-broadcast service for roaming is however not yet supported, i.e. there is no support for MBS service for roaming UEs. Accordingly, there is room for enhancement and/or improvement in this regard.

FIG. 4 shows a flowchart of a method or process at/by an apparatus according to at least one example embodiment. The apparatus may be or, stated in other words, the method or process may be a method or process of (or, stated in other words, operable or for use in/by) a user equipment (UE) as an example of a wireless device or entity.

As shown in FIG. 4, the method or process comprises a step/operation (S410) of receiving UE configuration for multicast-broadcast service (which may be referred to as UE MBS configuration), said UE configuration comprising UE MBS roaming authorization information indicating an MBS service access authorization when (for, for the case of) roaming in a network other than its home network, and a step/operation (S420) of determining allowance or disallowance of MBS service access based on the UE MBS roaming authorization information when the UE is roaming in a network other than its home network.

As shown in FIG. 4, the method or process may further comprise a step/operation (S430) of performing control in accordance with determination of allowance or disallowance of MBS service access. Such control may comprise (controlling) various functions, tasks actions or the like, such as e.g. a step/operation of displaying one or more allowed and/or disallowed MBS services for user information and/or selection, a step/operation (S435) of controlling access to one or more MBS services, such as e.g. initiating accessing an MBS service in a network when determining allowance to access the MBS service or inhibiting accessing an MBS service in a network when determining disallowance to access the MBS service.

Further, even if not shown in FIG. 4, the method or process may also comprise a step/operation of saving or storing the UE MBS configuration, or at least the UE MBS roaming authorization information, e.g. to a non-volatile memory, e.g. after/upon receipt thereof, and/or a step/operation of loading the UE MBS configuration, or at least the UE MBS roaming authorization information, e.g. from a non-volatile memory, e.g. into a volatile memory, working memory or processor, e.g. after/upon re-/start or power-on of the UE or when needed (e.g. during runtime). When the UE MBS configuration, or at least the UE MBS roaming authorization information, is included, provided or defined in some container, frame, structure, data structure, file or the like, such container, frame, structure, data structure, file or the like may be saved/stored and/or loaded or used as a (logical) unit for saving/storing and/or loading.

The UE configuration may be included, provided or defined in some container, frame, structure, data structure, file or the like. For example, the UE configuration may be included, provided or defined per management object, such as e.g. in a multicast-broadcast UE pre-configuration Management Object (MO), or the UE configuration may be included, provided or defined per subscriber identity module, such as e.g. in a Universal Subscriber Identity Module (USIM) or a USIM application on a Universal Integrated Circuit Card (UICC) or a file of a USIM application.

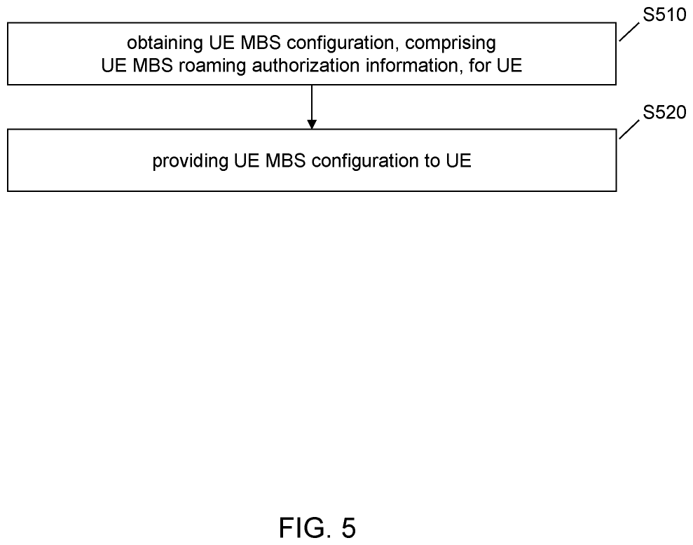

FIG. 5 shows a flowchart of a method or process at/by an apparatus according to at least one example embodiment. The apparatus may be or, stated in other words, the method or process may be a method or process of (or, stated in other words, operable or for use in/by) a network entity (such as any kind of base station or the like) or an operator entity (of the operator of the UE's home network) as an example of a network device or entity.

As shown in FIG. 5, the method or process comprises a step/operation (S510) of obtaining UE configuration for multicast-broadcast service (which may be referred to as UE MBS configuration) for a user equipment (UE), said UE configuration comprising UE MBS roaming authorization information indicating an MBS service access authorization when (for, for the case of) roaming in a network other than its home network, and a step/operation (S520) of providing said UE configuration for multicast-broadcast service (UE MBS configuration) to said user equipment (UE).

The UE configuration may be included, provided or defined in some container, frame, structure, data structure, file or the like. For example, the UE configuration may be included, provided or defined per management object, such as e.g. in a multicast-broadcast UE pre-configuration Management Object (MO), or the UE configuration may be included, provided or defined per subscriber identity module, such as e.g. in a Universal Subscriber Identity Module (USIM) or a USIM application on a Universal Integrated Circuit Card (UICC) or a file of a USIM application.

The UE configuration may be constructed, designed or configured in consideration of the home network operator's agreements with other operators, i.e. operator/s of other PLMNs and/or SNPNs and/or PNI-NPNs in terms of MBS service access allowance or disallowance for the home network operator's UEs in the network/s of the other operator/s.

Even if not shown in FIG. 5, the obtaining step/operation may comprise establishing the UE configuration, e.g. when the apparatus is an operator entity, or receiving the UE configuration, e.g. when the apparatus is a network entity. Further, the UE configuration may be transmitted to the UE, e.g. a multicast-broadcast UE pre-configuration Management Object (MO) including, providing or defining the UE configuration may be transmitted or programmed (or otherwise included or incorporated) to the UE, or the UE configuration may be delivered, e.g. the USIM or UICC may be delivered to a user of the UE for introducing into the UE (or otherwise included or incorporated to the UE).

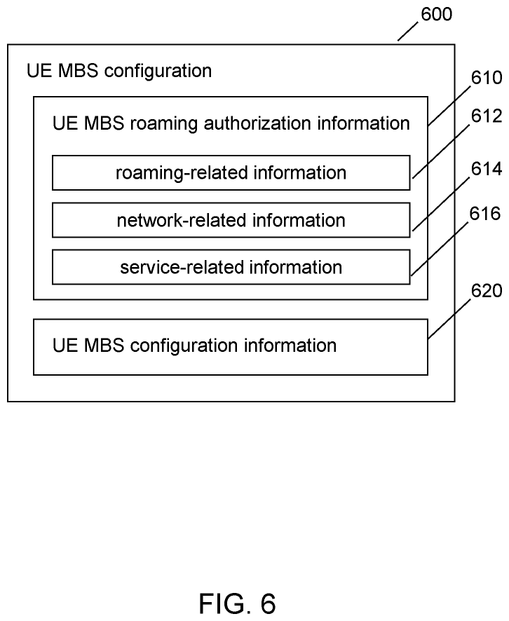

FIG. 6 shows a schematic diagram of an example of UE MBS configuration according to at least one example embodiment.

As shown in FIG. 6, a UE MBS configuration (UE configuration for multicast-broadcast service) 600 represents a configuration of a UE. The UE MBS configuration 600 comprises UE MBS roaming authorization information 610 and may also comprise UE MBS configuration information 620. The UE MBS roaming authorization information 610 indicates an MBS service access authorization for roaming, i.e. when the UE roaming in a network other than its home network, which is or comprises at least part of a configuration for enabling determining allowance or disallowance of MBS service access for one or more MBS services. Such MBS service access authorization indicates an access authorization in/for the case of roaming (of the UE, in a visited network other than its home network), i.e. a configuration for the UE which is (to be) used by the UE when/during roaming, while the UE can be configured with such MBS service access authorization independent of its current (non-/roaming state), i.e. the UE can be configured for the roaming case when it is currently not roaming but served/handled by its home network. The UE MBS configuration information 620 indicates an MBS service access configuration, which is or comprises at least part of a configuration for enabling accessing one or more MBS services.

For example, when a UE is provided/configured with a UE MBS configuration 600 comprising UE MBS roaming authorization information 610 and UE MBS configuration information 620, the UE is enabled to determine allowance or disallowance of MBS service access based on the UE MBS roaming authorization information when the UE is roaming in a network other than its home network, and the UE is enabled to initiate or inhibit accessing an MBS service in a network based on the UE MBS configuration information after determining allowance or disallowance to access the MBS service based on the UE MBS roaming authorization information when the UE is roaming in the network which is a network other than its home network.

In some example embodiments, when/during roaming, a UE configured with the UE MBS roaming authorization information 610 may determine whether it is authorized to access broadcast and/or multicast MBS services in the serving/visited PLMN or the serving/accessed SNPN/PNI-NPN. If it is authorized, the UE may then use the UE MBS configuration information 620 to access the corresponding allowed MBS services, if available. If it is not authorized, the UE may not attempt to access any or the corresponding disallowed MBS services.

In various example embodiments, the UE MBS roaming authorization information 610 may comprise roaming-related information 612 and/or network-related information 614 and/or service-related information 616. The roaming-related information 612, the network-related information 614 and the service-related information 616 may be regarded as information of different levels/hierarchies. The roaming-related information 612 may represent an upper level/hierarchy, defining the UE's allowance or disallowance of MBS service access when (or, for the case of) roaming on a general basis. The network-related information 614 may represent a middle level/hierarchy, defining the UE's allowance or disallowance of MBS service access when (or, for the case of) roaming on a network basis. The service-related information 616 may represent a lower level/hierarchy, defining the UE's allowance or disallowance of MBS service access when (or, for the case of) roaming on a service basis.

The roaming-related information 612, which are denoted accordingly for ease of reference, is or comprise information about whether the UE is allowed or disallowed (forbidden) to access MBS services when (or, for the case of) roaming. The roaming-related information 612 may relate to or be related to at least one of an MBS service type and a network in which the UE is roaming, and/or may identify or indicate the MBS service type and/or the network and/or a type of the network. The MBS service type may comprise or relate to multicast and broadcast MBS services, multicast MBS services or broadcast MBS services. The network in which the UE is roaming may comprise or relate to a public network, such as a PLMN, or a non-public network, such as a SNPN or a PNI-NPN.

Stated differently, the roaming-related information 612 may be or comprise information whether the UE is allowed or disallowed (forbidden) to access MBS services when/during roaming in or visiting other PLMNs and/or when/during roaming in or accessing SNPNs/PNI-NPNs. This information may relate to both multicast and broadcast MBS services, or specific/separate information may be provided for multicast MBS services and/or broadcast MBS services. This information may relate both to roaming in or visiting other PLMNs and roaming in or accessing SNPNs/PNI-NPNs, or specific/separate information may be provided for roaming in or visiting other PLMNs and/or roaming in or accessing SNPNs/PNI-NPNs.

The network-related information 614, which are denoted accordingly for ease of reference, is or comprise information about one or more networks in which the UE is allowed or disallowed (forbidden) to access MBS services when/during roaming in said one or more networks. The network-related information 614 may relate to or be related to the one or more networks or the one or more networks and an MBS service type, and/or may identify or indicate the one or more networks or the one or more networks and an MBS service type. The MBS service type may comprise or relate to multicast and broadcast MBS services, multicast MBS services or broadcast MBS services.

Stated differently, the network-related information 614 may be or comprise information about PLMN IDs and/or SNPN/PNI-NPN IDs where the UE is allowed or disallowed (forbidden) to access MBS services. This information may relate to both multicast and broadcast MBS services, or specific/separate information may be provided for multicast MBS services and/or broadcast MBS services.

The service-related information 616, which are denoted accordingly for ease of reference, is or comprise information about one or more MBS services which the UE is allowed or disallowed to access when/during roaming. The service-related information 616 may relate to or be related to the one or more MBS services or the one or more MBS services and one or more networks in which the UE is allowed or disallowed (forbidden) to access the one or more MBS services when/during roaming in said one or more networks, and/or may identify or indicate the one or more MBS services or the one or more MBS services and one or more networks in which the UE is allowed or disallowed (forbidden) to access the one or more MBS services when/during roaming in said one or more networks. In the service-related information 616, an MBS service may be identified or indicated by a temporary mobile group identifier (TMGI) or a source-specific (IP) multicast address (SSM).

Stated differently, the service-related information 616 may be or comprise information about specific one or more MBS services that the UE is allowed or disallowed (forbidden) to access. The service-related information 616 may be applicable for, or—stated differently—the specific one or more MBS services may be allowed or disallowed (forbidden) to be accessed in, all other networks (network-generic/default case) or in specific one or more other networks (network-specific case).

Below, a use case is exemplarily described, in which the UE configuration for multicast-broadcast service (UE MBS configuration) is realized by MO(-based) configuration. For example, the UE MBS configuration is included, provided or defined in a multicast-broadcast UE pre-configuration Management Object (MO).

In example embodiments, UE MBS configuration may be based on (pre-) configuration of information for services using MBS using MO (pre-) configuration.

For illustrative purposes, yet without limiting example embodiments thereto, the MO use case is described with reference to a multicast-broadcast UE pre-configuration MO with a structure on the basis of the structure specified in 3GPP TS 24.575 V18.0.0.

3GPP TS 24.575 V18.0.0 defines a management object (MO) that can be used to configure the UE with parameters related to reception of data of MBS services. The MO is compatible with the OMA Device Management (DM) protocol specifications and is defined using the OMA DM device description framework (DDF), where the configuration parameters are delivered from a so-called OMA DM server to an OMA client that can be located in the UE. If the UE is pre-configured with information related to services using MBS, the UE can discover and receive data for services by using the provisioned configuration; otherwise, the UE may discover the available MBS services in the serving PLMN by other means e.g. using MBS user service announcement.

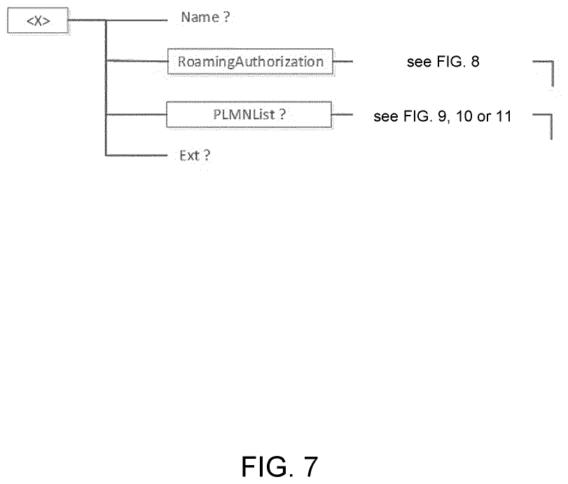

FIG. 7 shows a schematic diagram of an example structure (e.g. data structure) of/for UE MBS configuration according to at least one example embodiment.

As shown in FIG. 7, the structure comprises, under a placeholder leaf denoted by <X>, a name leaf for a name for the UE pre-configuration MO settings, a RoamingAuthorization node (as a placeholder) for per-UE roaming configuration, and a PLMNList node (as a placeholder) for per-PLMN configuration.

In this structure, the UE MBS roaming authorization information may be included, provided or defined as or in the (at least one) RoamingAuthorization node as an example of a dedicated roaming authorization node in the multicast-broadcast UE pre-configuration MO, and/or in the (at least one) PLMNList node as an example of a per-network configuration node in the multicast-broadcast UE pre-configuration MO.

In this structure, the (at least one) RoamingAuthorization node may include, provide or define (at least part of) the UE MBS roaming authorization information, and/or the (at least one) PLMNList node may include, provide or define (at least part of) the UE MBS roaming authorization information and/or the UE MBS configuration information.

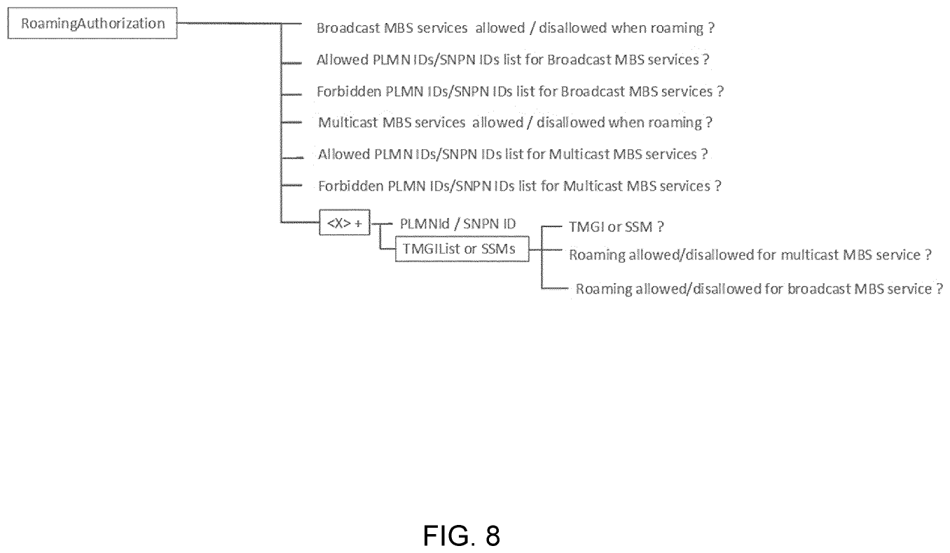

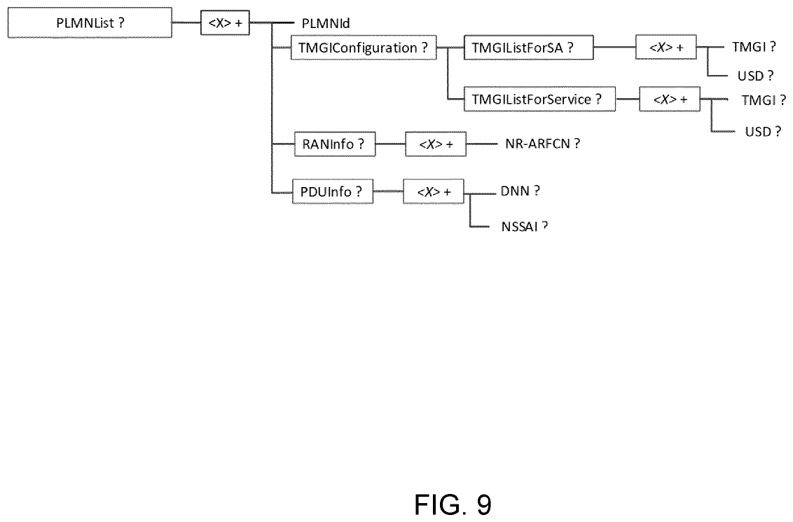

In an example embodiment, the (at least one) RoamingAuthorization node may include, provide or define the UE MBS roaming authorization information, and the (at least one) PLMNList node may include, provide or define the UE MBS configuration information. This is illustrated by a FIGS. 8 and 9 in view of FIG. 7.

FIG. 8 shows a schematic diagram of an example structure (e.g. data structure) of/for at least part of UE MBS roaming authorization information according to at least one example embodiment.

As shown in FIG. 8, the structure of the RoamingAuthorization node (see FIG. 7) comprises various nodes which include, provide or define roaming-related information, network-related information and service-related information. The roaming-related information is represented by “Broadcast MBS services allowed/disallowed when roaming” and “Multicast MBS services allowed/disallowed when roaming”, as roaming-related information relating to broadcast MBS services and multicast MBS services, respectively. The network-related information is represented by “Allowed PLMN IDs/SNPN IDs list for Broadcast MBS services” and “Forbidden PLMN IDs/SNPN IDs list for Broadcast MBS services” as network-related information relating to broadcast MBS services, and by “Allowed PLMN IDs/SNPN IDs list for Multicast MBS services” and “Forbidden PLMN IDs/SNPN IDs list for Multicast MBS services” as network-related information relating to multicast MBS services. The service-related information is represented by (the contents of) placeholder (sub-) node denoted by <X>, namely PLMNId/SNPN ID as network identification and a node denoted by “TMGIList or SSMs” (and its contents). By way of this service-related information, information on the allowance or disallowance of specific MBS services as identified by any TMGI or SSM in the node “TMGIList or SSMs” is represented by “Roaming allowed/disallowed for multicast MBS service” and/or “Roaming allowed/disallowed for broadcast MBS service”, wherein this service-specific authorization information is applicable/valid for the network identified by PLMNId/SNPN ID.

It is to be noted that the structure of FIG. 8, i.e. the contents of the (at least one) RoamingAuthorization node may also include, provide or define only a part of the illustrated information, i.e. any conceivable sub-set thereof, such as e.g. only roaming-related information or roaming-related information and network- or service-related information (or part thereof).

FIG. 9 shows a schematic diagram of an example structure (e.g. data structure) of/for at least part of UE MBS configuration information according to at least one example embodiment.

As shown in FIG. 9, the structure of the PLMNList node (see FIG. 7) comprises various nodes which include, provide or define UE MBS configuration information. For each PLMN, the following information is given:
a) PLMN ID of the PLMN for which the configuration applies;
b) RAN information based on NR-ARFCN on which the broadcast/multicast MBS service is available;
c) list of TMGI, on which the broadcast/multicast MBS service is available, along with the associated user service description (USD) information for the broadcast/multicast MBS service. If TMGI and USD information for the MBS user service is configured for the PLMN selected for broadcast/multicast MBS service, the UE uses the information configured therein to acquire the broadcast/multicast MBS service;
d) list of TMGI, on which the service announcement for broadcast/multicast MBS service is available along with the associated USD information for the broadcast/multicast MBS user service announcement service. If TMGI and USD information for MBS user service announcement is configured for a PLMN selected for broadcast/multicast MBS service, the UE uses the information configured therein to acquire the service announcement (SA) for broadcast/multicast MBS service; and
e) PDU session information based on DNN and S-NSSAI pair associated with an MBS session.

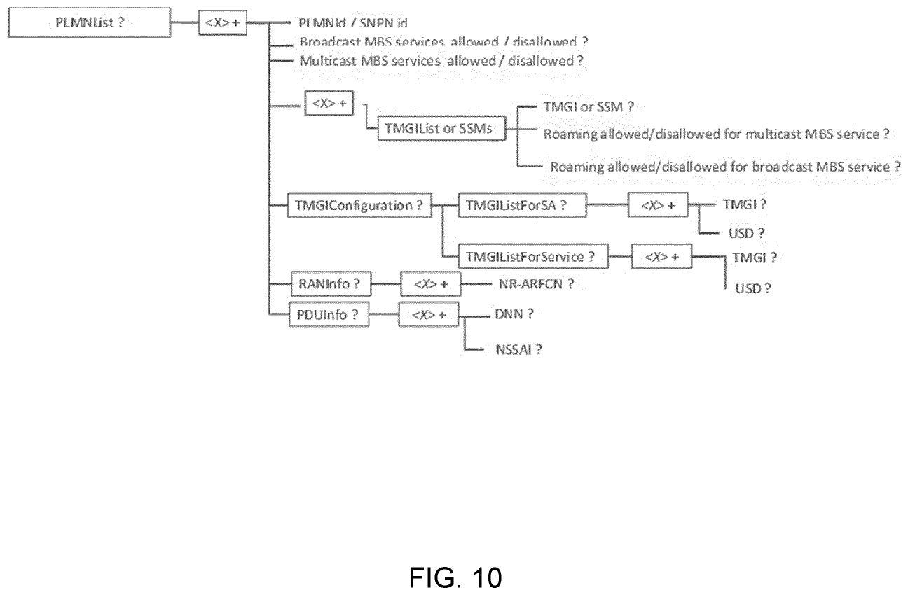

In an example embodiment, the (at least one) RoamingAuthorization node may or may not include, provide or define roaming-related information of the UE MBS roaming authorization information, and the (at least one) PLMNList node may include, provide or define network-related information and/or service-related information of the UE MBS roaming authorization information in addition to the UE MBS configuration information. This is illustrated by a combination of FIG. 10 in view of FIG. 7 (while it is to be noted that the RoamingAuthorization node in FIG. 7 is not required and can be omitted in the structure of the multicast-broadcast UE pre-configuration MO when the UE MBS roaming authorization information do not comprise roaming-related information).

FIG. 10 shows a schematic diagram of an example structure (e.g. data structure) of/for at least part of UE MBS roaming authorization information according to at least one example embodiment.

As shown in FIG. 10, the structure of the PLMNList node (see FIG. 7) comprises, in addition to the UE MBS configuration information (as described above in connection with FIG. 9), network-related information and service-related information of the UE MBS roaming authorization information. Further, the PLMNId may be replaced by PLMNId/SNPN ID so as to cover the PLMN and SNPN roaming cases. The network-related information is represented by “Broadcast MBS services allowed/disallowed” as network-related information relating to broadcast MBS services for/in the indicated PLMN/SNPN as identified by PLMNId/SNPN ID, and by “Multicast MBS services allowed/disallowed” as network-related information relating to multicast MBS services for/in the indicated PLMN/SNPN as identified by PLMNId/SNPN ID. The service-related information is represented by (the contents of) placeholder (sub-) node denoted by <X>, namely a node denoted by “TMGIList or SSMs” (and its contents). By way of this service-related information, information on the allowance or disallowance of specific MBS services as identified by any TMGI or SSM in the node “TMGIList or SSMs” is represented by “Roaming allowed/disallowed for multicast MBS service” and/or “Roaming allowed/disallowed for broadcast MBS service”, wherein this service-specific authorization information is applicable/valid for the network identified by PLMNId/SNPN ID.

It is to be noted that the structure of FIG. 10, i.e. the contents of the (at least one) PLMNList node may also include, provide or define only a part of the illustrated information, at least in terms of the UE MBS roaming authorization information, such as e.g. only network-related information or service-related information (or part thereof).

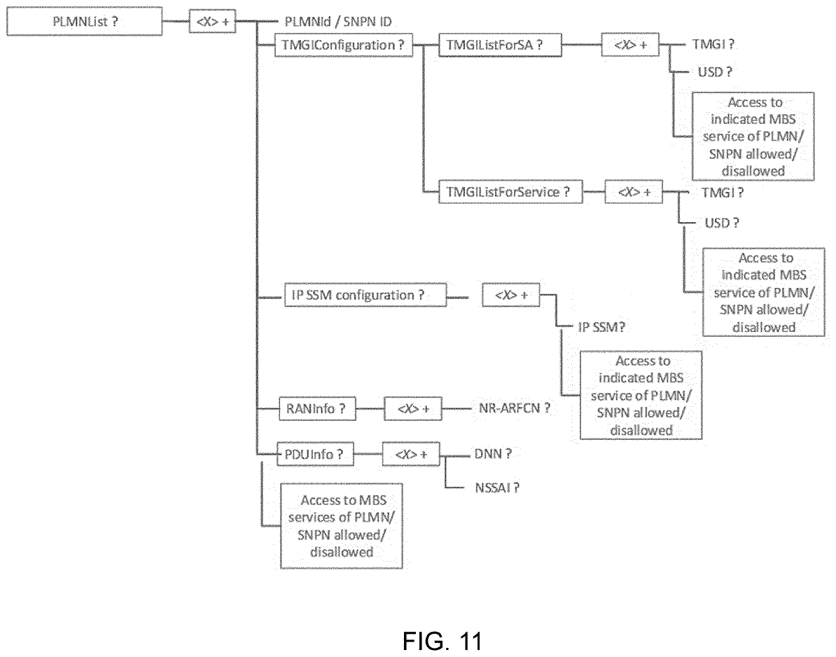

In an example embodiment, the (at least one) RoamingAuthorization node may or may not include, provide or define roaming-related information of the UE MBS roaming authorization information, and the (at least one) PLMNList node may include, provide or define network-related information and/or service-related information of the UE MBS roaming authorization information in addition to the UE MBS configuration information. This is illustrated by a combination of FIG. 11 in view of FIG. 7 (while it is to be noted that the RoamingAuthorization node in FIG. 7 is not required and can be omitted in the structure of the multicast-broadcast UE pre-configuration MO when the UE MBS roaming authorization information do not comprise roaming-related information).

FIG. 11 shows a schematic diagram of an example structure (e.g. data structure) of/for at least part of UE MBS roaming authorization information according to at least one example embodiment.

As shown in FIG. 11, the structure of the PLMNList node (see FIG. 7) comprises, in addition to the UE MBS configuration information (as described above in connection with FIG. 9), network-related information and service-related information of the UE MBS roaming authorization information. Further, the PLMNId may be replaced by PLMNId/SNPN ID so as to cover the PLMN and SNPN roaming cases. The network-related information is represented by “Access to MBS services of PLMN/SNPN allowed/disallowed” as network-related information relating to broadcast/multicast MBS services for/in the indicated PLMN/SNPN as identified by PLMNId/SNPN ID. The service-related information is represented by any one of “Access to indicated MBS service of PLMN/SNPN allowed/disallowed” under node “TMGIListForSA”, “TMGIListForService” and “IP SSM configuration”, respectively. By way of this service-related information, information on the allowance or disallowance of specific MBS services as identified by any TMGI or SSM for service announcement, any TMGI or SSM for service and any IP SSM is given, wherein this service-specific authorization information is applicable/valid for the network identified by PLMNId/SNPN ID.

In FIG. 11, extensions at the left branch are shown to express whether in the indicated PLMN or SNPN access to MBS services is allowed or disallowed. The entries can either apply both to multicast MBS services and broadcast MBS services (as shown in the figure), or separate entries for multicast MBS services and broadcast MBS services can be provided. The generic entries for a PLMN or SNPN can be superseded by entries for specific services, as shown in the extensions at the right branch of the figure. For a specific service indicated by a TMGI or IP specific multicast address, an extension expresses whether access to that MBS service is allowed or disallowed. Each of the extensions at the right branch of the figure may be regarded as a dedicated service access leaf which includes, provides or defines service-related information of the UE MBS roaming authorization information.

It is to be noted that the structure of FIG. 11, i.e. the contents of the (at least one) PLMNList node may also include, provide or define only a part of the illustrated information, at least in terms of the UE MBS roaming authorization information, such as e.g. only network-related information or service-related information (or part thereof).

Below, a use case is exemplarily described, in which the UE configuration for multicast-broadcast service (UE MBS configuration) is realized by USIM(-based) configuration. For example, the UE MBS configuration is included, provided or defined in a USIM or a USIM application on a UICC or a file of a USIM application.

In example embodiments, UE MBS configuration may be based on (pre-)configuration of information for services using MBS using USIM (pre-)configuration.

For illustrative purposes, yet without limiting example embodiments thereto, the USIM use case is described with reference to a UE pre-configuration file (EF) with a structure on the basis of the structure specified in 3GPP TS 31.102 V18.0.0.

3GPP TS 31.102 V18.0.0 defines an elementary file, called EF_{5MBSUECONFIG}, that can be used to configure the UE with parameters related to reception of data of MBS service, in the ADF of USIM which is configured and provided by the operator for being inserted into the UE. Hence, the UE can be pre-configured with information related to services using MBS so as to enable reception of data by way of the USIM file EF_{5MBSUECONFIG} (5MBS UE pre-configuration). Here, the USIM file EF_{5MBSUECONFIG} (5MBS UE pre-configuration) represents or stands for any one of a USIM or a USIM application or a file of a USIM application.

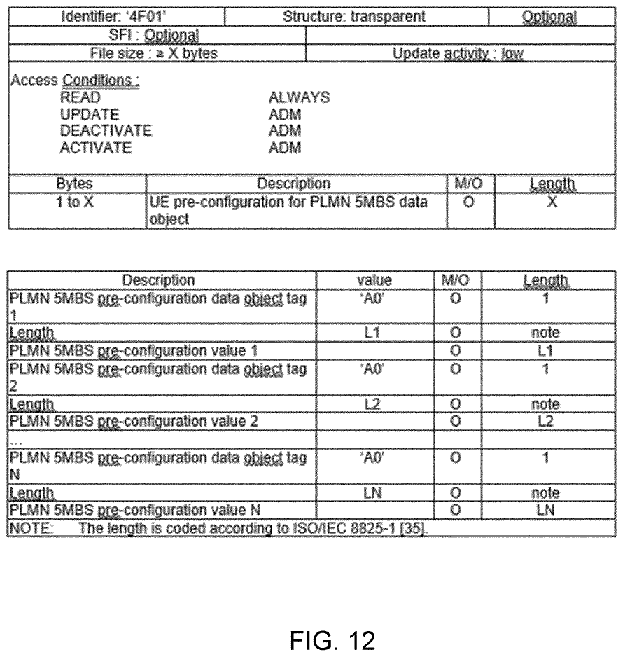

FIG. 12 shows a schematic diagram of an example structure (e.g. data structure) of/for UE MBS configuration according to at least one example embodiment.

In the upper part of FIG. 12, there is shown the structure of USIM file EF_{5MBSUECONFIG} (5MBS UE pre-configuration). If service n^{o} 147 is “available” in EF_{UST} (USIM Service Table), this file/EF shall be present, which contains the configuration of the parameters related to UE pre-configuration for 5MBS service.

In the lower part of FIG. 12, there is shown the structure of “UE pre-configuration for PLMN 5MBS data object” in USIM file EF_{5MBSUECONFIG} (5MBS UE pre-configuration). This data object is structured/coded in a number of TLV elements, here numbered by 1, 2 . . . . N, each TLV element comprising a tag sub-/element, a length sub-/element and a value sub-/element.

In this structure, the UE MBS roaming authorization information may be included, provided or defined as or in the (at least one) configuration data object, i.e. “UE pre-configuration for PLMN 5MBS data object”, in the USIM file EF_{5MBSUECONFIG} (5MBS UE pre-configuration).

In this structure, the (at least one) configuration data object, i.e. “UE pre-configuration for PLMN 5MBS data object”, in the USIM file EF_{5MBSUECONFIG} (5MBS UE pre-configuration) may include, provide or define (at least part of) the UE MBS roaming authorization information and/or (at least part of) the UE MBS configuration information.

In an example embodiment, any one of the roaming-related information of the UE MBS roaming authorization information, the network-related information of the UE MBS roaming authorization information and the service-related information of the UE MBS roaming authorization information, as well as the UE MBS configuration information, may be included, provided or defined in or by at least one TLV element in the configuration data object, i.e. “UE pre-configuration for PLMN 5MBS data object”, in the USIM file EF_{5MBSUECONFIG} (5MBS UE pre-configuration), respectively.

In an example embodiment, the configuration data object, i.e. “UE pre-configuration for PLMN 5MBS data object”, in the USIM file EF_{5MBSUECONFIG} (5MBS UE pre-configuration) may comprise one or more of: at least one TLV element which includes, provides or defines the roaming-related information of the UE MBS roaming authorization information, at least one TLV element which includes, provides or defines the network-related information of the UE MBS roaming authorization information, and at least one TLV element which includes, provides or defines the service-related information of the UE MBS roaming authorization information. Further, the configuration data object, i.e. “UE pre-configuration for PLMN 5MBS data object”, in the USIM file EF_{5MBSUECONFIG} (5MBS UE pre-configuration) may comprise one or more of: at least one TLV element which includes, provides or defines the UE MBS configuration information.

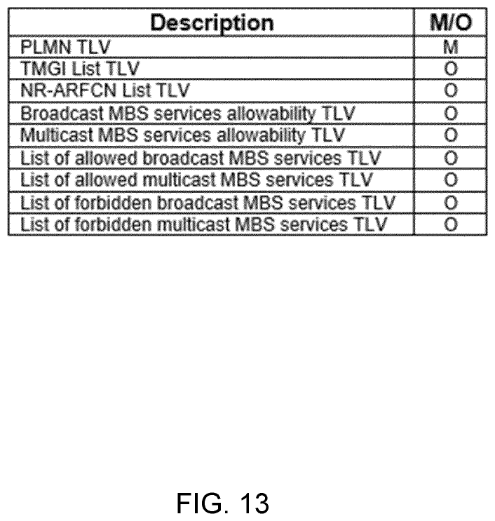

FIG. 13 shows a schematic diagram of an example structure (e.g. data structure) of/for at least part of UE MBS roaming authorization information and at least part of UE MBS configuration information according to at least one example embodiment.

As shown in FIG. 13, the structure of the “UE pre-configuration for PLMN 5MBS data object” in the USIM file EF_{5MBSUECONFIG} (see FIG. 12) comprises various TLV elements which include, provide or define UE MBS configuration information and UE MBS roaming authorization information. The UE MBS configuration information is represented by “PLMN TLV”, “TMGI List TLV” and “NR-ARFCN List TLV”. The contents/significance of these TLV elements is similar to nodes “PLMNId”, “TMGIConfiguration” and “RANInfo” in the multicast-broadcast UE pre-configuration MO in the MO use case described above, and hence reference is made to this description for the sake of simplicity.

The roaming-related information is represented by “Broadcast MBS services allowability TLV” and “Multicast MBS services allowability TLV”, as roaming-related information relating to broadcast MBS services and multicast MBS services, respectively. The service-related information is represented by “List of allowed broadcast MBS services TLV” and “List of forbidden broadcast MBS services TLV” as service-related information relating to broadcast MBS services, and by “List of allowed multicast MBS services TLV” and “List of forbidden multicast MBS services TLV” as service-related information relating to multicast MBS services, wherein this service-specific authorization information is applicable/valid for the network identified by PLMNId specified in “PLMN TLV” (which may be replaced by e.g. “PLMN/SNPN List” specifying PLMNId/SNPN ID).

It is to be noted that the structure of FIG. 13, i.e. the contents of the configuration data object, i.e. “UE pre-configuration for PLMN 5MBS data object”, in the USIM file EF_{5MBSUECONFIG} (5MBS UE pre-configuration) may also include, provide or define only a part of the illustrated information or other information, at least in terms of the UE MBS roaming authorization information, such as e.g. only roaming-related information, only service-related information or all of roaming-related information, network-related information and service-related information (or part thereof).

For example, the “Broadcast MBS services allowability TLV” in the configuration data object, i.e. “UE pre-configuration for PLMN 5MBS data object”, in the USIM file EF_{5MBSUECONFIG} (5MBS UE pre-configuration), which contains whether the broadcast MBS services are allowed while the UE is roaming in the identified PLMN, may be structured/coded as follows.

| | | | Length |
|---|---|---|---|
| Description | Value | M/O | (bytes) |
| Broadcast MBS services allowability | ‘XX’ | M | 1 |
| TLV Tag | | | |
| Length | 1 | M | 1 |
| Broadcast MBS services allowability | 0 (for “not | M | 1 |
| value | allowed”) or 1 | | |
| | (for “allowed”) | | |

For example, the “Multicast MBS services allowability TLV” in the configuration data object, i.e. “UE pre-configuration for PLMN 5MBS data object”, in the USIM file EF_{5MBSUECONFIG} (5MBS UE pre-configuration), which contains whether the multicast MBS services are allowed while the UE is roaming in the identified PLMN, may be structured/coded as follows.

| | | | Length |
|---|---|---|---|
| Description | Value | M/O | (bytes) |
| Multicast MBS services allowability | ‘XX’ | M | 1 |
| TLV Tag | | | |
| Length | 1 | M | 1 |
| Multicast MBS services allowability | 0 (for “not | M | 1 |
| value | allowed”) or 1 | | |
| | (for “allowed”) | | |

For example, the “List of allowed broadcast MBS services TLV” in the configuration data object, i.e. “UE pre-configuration for PLMN 5MBS data object”, in the USIM file EF_{5MBSUECONFIG} (5MBS UE pre-configuration), which contains a list of allowed broadcast MBS services while the UE is roaming in the identified PLMN, may be structured/coded as follows.

| | | | Length |
|---|---|---|---|
| Description | Value | M/O | (bytes) |
| Allowed broadcast MBS services List | ‘YY’ | M | 1 |
| Tag | | | |
| Length | ‘ZZ’ | M | ‘TT’ |
| Allowed broadcast MBS services entry | — | M | ‘NN’ |
| #1 | | | |
| Allowed broadcast MBS services entry | — | O | ‘NN’ |
| #2 | | | |
| . . . | | | |
| Allowed broadcast MBS services entry | — | O | ‘NN’ |
| #n | | | |

For example, any one of the “List of allowed multicast MBS services TLV”, the “List of forbidden broadcast MBS services TLV” and the “List of forbidden multicast MBS services TLV” in the configuration data object, i.e. “UE pre-configuration for PLMN 5MBS data object”, in the USIM file EF_{5MBSUECONFIG} (5MBS UE pre-configuration), which contain respective lists of allowed/forbidden multicast-broadcast MBS services while the UE is roaming in the identified PLMN, may be structured/coded in a similar manner as the “List of allowed broadcast MBS services TLV”. That is, in the above-shown structure/coding, “broadcast” may be replaced by “multicast” and/or “ ”allowed” may be replaced by “forbidden”, as appropriate.

With regard to the above use cases and example embodiments, it is to be noted that these are given for illustrative purposes, without being intended to restrict the present disclosure thereto. In particular, the individual structures and names/denominations of nodes or leaves (in the MO use case) and sub-/elements, fields or parameters (in the USIM use case) are exemplary and non-limiting. Any one of these structures and names/denominations may be changes, as long as the thus described information can be provided and/or the thus described significance is maintained. Just to name some examples, a dedicated roaming authorization node in a multicast-broadcast UE configuration MO does not need to be denoted by RoamingAuthorization, and roaming-related information in the USIM use case does not need to be denoted by “Broadcast MBS services allowability TLV” or “Broadcast MBS services allowability TLV”, but different names/denominations can be adopted.

As described above, various example embodiments provide a technique for (e.g. enabling/realizing enhancements and/or improvements for) UE MBS roaming configuration, i.e. UE configuration for multicast-broadcast service (MBS) for roaming. Namely, there are provided measures/mechanisms (including methods, apparatuses (i.e. devices, entities, elements, instances and/or functions) for (e.g. enabling/realizing enhancements and/or improvements for) UE MBS roaming configuration, i.e. UE configuration for multicast-broadcast service (MBS) for roaming.

As described above, various example embodiments enable a UE to be configured in terms of MBS service access authorization when roaming, namely to configure a UE with information on whether and/or to which extent (in terms of network/s and MS service/s) the UE is allowed or disallowed to access broadcast and/or multicast MBS services when/during roaming in other networks than its home network. Thereby, using (additional) UE MBS roaming authorization information, UE configuration can be enhanced/improved for roaming cases, scenarios or environments.

The above-described functionality as well as its related operations, procedures, methods and processes may be implemented by respective functional elements, entities, modules, units, processors, or the like, as described below. These functional elements, entities, modules, units, processors, or the like, i.e. the implementation of one or more example embodiments, may be realized in a cloud environment, by SDN, by NFV/NFVI, or the like.

While various example embodiments are described with reference to operations, procedures, methods and processes, these example embodiments also cover respective apparatuses, entities, modules, units, network nodes and/or systems, including software and/or hardware thereof.

Respective example embodiments are described below, while for the sake of brevity reference is made to the detailed description of respective corresponding configurations/setups, schemes, structures, processes, sequences, methods as well as functionalities, principles and operations according to FIGS. 4 to 13.

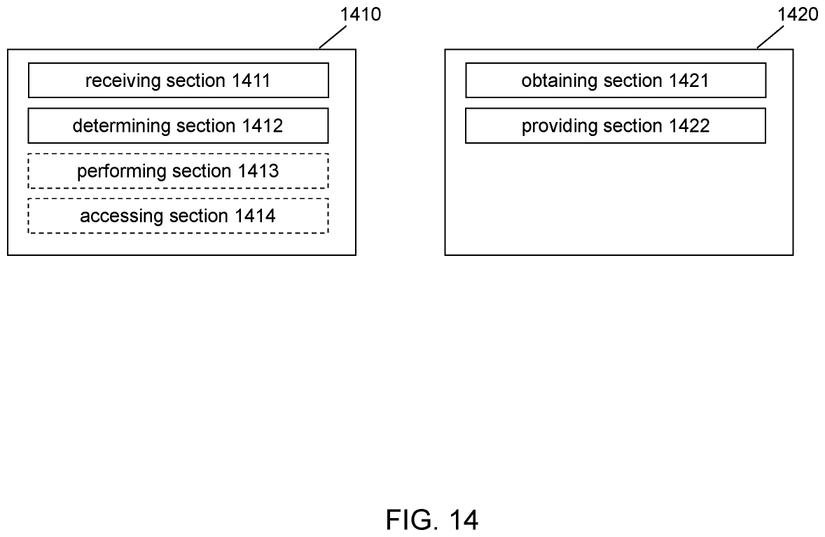

FIG. 14 shows a schematic block diagram illustrating a structure of apparatuses according to at least one example embodiment.

In FIG. 14, the blocks are basically configured to perform respective methods, procedures and/or functions as described above. It is to be noted that the individual blocks are meant to illustrate respective functional blocks implementing a respective function, process or procedure, respectively. Such functional blocks are implementation-independent, i.e. may be implemented by means of any kind of hardware or software or combination thereof, respectively.

According to at least one example embodiment, an apparatus according to at least one example embodiment may represent or realize/embody a (e.g., part of a) a user equipment (UE) as an example of a wireless device or entity.

Such apparatus may be illustrated or realized as is shown in FIG. 2. The apparatus or its at least one processor 220 (e.g., together with instructions stored in its at least one memory 230) may be configured to receive UE configuration for multicast-broadcast service (MBS), said UE configuration comprising UE MBS roaming authorization information indicating an MBS service access authorization when roaming in a network other than its home network, and to determine allowance or disallowance of MBS service access based on the UE MBS roaming authorization information when the UE is roaming in a network other than its home network.

Further, the apparatus or its at least one processor 220 (e.g., together with instructions stored in its at least one memory 230) may be configured to perform control in accordance with determination of allowance or disallowance of MBS service access. Such control may comprise initiating, or inhibiting accessing an MBS service in a network after determining allowance or disallowance to access the MBS service based on the UE MBS roaming authorization information when the UE is roaming in the network which is a network other than its home network. Also, the apparatus or its at least one processor 220 (e.g., together with instructions stored in its at least one memory 230) may be configured to store/save the UE configuration for multicast-broadcast service (MBS), e.g. in memory 230, and/or to load the UE configuration for multicast-broadcast service (MBS), e.g. from memory 230.

Such apparatus may be illustrated or realized as is shown in FIG. 14 as apparatus 1410. The apparatus 1410 may comprise (at least) one or more unit/means/circuitry, denoted by receiving section 1411, which represent any implementation for (or configured to) receiving (receive) UE configuration for multicast-broadcast service (MBS), said UE configuration comprising UE MBS roaming authorization information indicating an MBS service access authorization when roaming in a network other than its home network, and (at least) one or more unit/means/circuitry, denoted by determining section 1412, which represent any implementation for (or configured to) determining (determine) allowance or disallowance of MBS service access based on the UE MBS roaming authorization information when the UE is roaming in a network other than its home network.

As indicated by dashed lines, the apparatus 1410 may comprise (at least) one or more unit/means/circuitry, denoted by performing section 1413, which represent any implementation for (or configured to) performing (perform) control in accordance with determination of allowance or disallowance of MBS service access. Also, the apparatus 1410 may comprise (at least) one or more unit/means/circuitry, denoted by accessing section 1414, which represent any implementation for (or configured to) accessing (access) an MBS service in a network, which may comprise initiating or inhibiting accessing an MBS service in a network after determining allowance or disallowance to access the MBS service based on the UE MBS roaming authorization information when the UE is roaming in the network which is a network other than its home network.

According to at least one example embodiment, an apparatus according to at least one example embodiment may represent or realize/embody a (e.g., part of a) network entity (such as any kind of base station or the like) or an operator entity (of the operator of the UE's home network) as an example of a network device or entity.

Such apparatus may be illustrated or realized as is shown in FIG. 3. The apparatus or its at least one processor 320 (e.g., together with instructions stored in its at least one memory 330) may be configured to obtain UE configuration for multicast-broadcast service (MBS) for a user equipment (UE), said UE configuration comprising UE MBS roaming authorization information indicating an MBS service access authorization when roaming in a network other than its home network, and to provide said UE configuration for multicast-broadcast service (MBS) to said user equipment (UE).

Such apparatus may be illustrated or realized as is shown in FIG. 14 as apparatus 1420. The apparatus 1420 may comprise (at least) one or more unit/means/circuitry, denoted by obtaining section 1421, which represent any implementation for (or configured to) obtaining (obtain) UE configuration for multicast-broadcast service (MBS) for a user equipment (UE), said UE configuration comprising UE MBS roaming authorization information indicating an MBS service access authorization when roaming in a network other than its home network, and (at least) one or more unit/means/circuitry, denoted by providing section 1422, which represent any implementation for (or configured to) providing (provide) said UE configuration for multicast-broadcast service (MBS) to said user equipment (UE).

For further details regarding the operability/functionality of the apparatuses (or units/means thereof) according to example embodiments, reference is made to the above description in connection with any one of FIGS. 1 to 13, respectively.

According to example embodiments, any one of the (at least one) processor, the (at least one) memory and the (at least one) interface, as well as any one of the illustrated units/means, may be implemented as individual modules, chips, chipsets, circuitries or the like, or one or more of them can be implemented as a common module, chip, chipset, circuitry or the like, respectively.

As used herein, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions), and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term herein, including in any claims. As a further example, as used herein, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

According to example embodiments, a system may comprise any conceivable combination of any depicted or described apparatuses and other network elements or functional entities, which are configured to cooperate as described above.

In general, it is to be noted that respective functional blocks or elements according to various embodiments described herein can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, a basic system architecture of a (tele) communication network including a mobile communication system where some examples of example embodiments are applicable may include an architecture of one or more communication networks including wireless access network sub-/system(s) and possibly core network(s). Such an architecture may include one or more communication network control elements or functions, such as e.g. access network elements, radio access network elements, access service network gateways or base transceiver stations, like a base station, an access point, a NodeB (NB), an eNB or a gNB, a distributed or a centralized unit, which controls a respective coverage area or cell(s) and with which one or more communication stations such as communication elements or functions, like user devices or terminal devices, like a UE, or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases and the like may be included.

The general functions and interconnections of the described elements and functions, which also depend on the actual network type, are known to those skilled in the art and described in corresponding specifications, so that a detailed description thereof is omitted herein. It should be appreciated that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of example embodiments may also be able to communicate with other networks, such as a public switched telephone network or the Internet, including the Internet-of-Things. The communication network may also be able to support the usage of cloud services for virtual network elements or functions thereof, wherein it is to be noted that the virtual network part of the (tele) communication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g. a cloud infrastructure.

Any method step is suitable to be implemented as software or by hardware without changing the idea or scope of the various example embodiments. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or units/means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

Various example embodiments also cover any conceivable combination of method steps and operations described above, and any conceivable combination of nodes, apparatuses, modules or elements described above, as long as the above-described concepts of methodology and structural arrangement are applicable.

In view of the above, there are provided measures for (e.g. enabling/realizing enhancements and/or improvements for) UE MBS roaming configuration, i.e. UE configuration for multicast-broadcast service (MBS) for roaming. Such measures may exemplarily comprise that a user equipment (UE) receives UE configuration for multicast-broadcast service (MBS), said UE configuration comprising UE MBS roaming authorization information indicating an MBS service access authorization when roaming in a network other than its home network, and determines allowance or disallowance of MBS service access based on the UE MBS roaming authorization information when the UE is roaming in a network other than its home network.

Even though various example embodiments are described above with reference to the accompanying drawings, it is to be understood that the various example embodiments are not restricted thereto. Rather, it is apparent to those skilled in the art that the various example embodiments can be modified in many ways without departing from the intended scope.

1-48. (canceled)

49. A user equipment (UE) comprising:
at least one processor, and
at least one memory storing instructions that, when executed by the user equipment, cause the user equipment at least to:
receive UE configuration for multicast-broadcast service (MBS), said UE configuration comprising UE MBS roaming authorization information indicating an MBS service access authorization when roaming in a network other than its home network, and
determine allowance or disallowance of MBS service access based on the UE MBS roaming authorization information when the UE is roaming in a network other than a home network of the UE.

50. The UE according to claim 49, wherein said UE MBS roaming authorization information comprises:
roaming-related information about whether the UE is allowed or disallowed to access MBS services when roaming.

51. The UE according to claim 50, wherein said roaming-related information relates to or is related to at least one of the following:
an MBS service type, or
the network in which the UE is roaming.

52. The UE according to claim 51, wherein
the MBS service type comprises or relates to multicast and broadcast MBS services, multicast MBS services or broadcast MBS services, and/or
the network in which the UE is roaming comprises a public land mobile network, or one of a standalone non-public network or a public network integrated non-public network.

53. The UE according to claim 51, wherein said roaming-related information identifies or indicates at least one of the following:
the MBS service type, or
the network in which the UE is roaming and/or a type of the network in which the UE is roaming.

54. The UE according to claim 49, wherein said UE MBS roaming authorization information comprises:
network-related information about one or more networks in which the UE is allowed or disallowed to access MBS services when roaming in said one or more networks.

55. The UE according to claim 54, wherein said network-related information identifies or indicates one of:
said one or more networks, or
said one or more networks and an MBS service type.

56. The UE according to claim 55, wherein
the MBS service type comprises or relates to multicast and broadcast MBS services, multicast MBS services or broadcast MBS services.

57. The UE according to claim 49, wherein said UE MBS roaming authorization information comprises:
service-related information about one or more MBS services which the UE is allowed or disallowed to access when roaming.

58. The UE according to claim 57, wherein said service-related information identifies or indicates one of:
said one or more MBS services, or
said one or more MBS services and one or more networks in which the UE is allowed or disallowed to access said one or more MBS services when roaming in said one or more networks.

59. A network or operator apparatus comprising:
at least one processor, and
at least one memory storing instructions that, when executed by the network or operator apparatus, cause the network or operator apparatus at least to:
obtain user equipment (UE) configuration for multicast-broadcast service (MBS) for a UE, said UE configuration comprising UE MBS roaming authorization information indicating an MBS service access authorization when the UE is roaming in a network other than a home network of the UE, and
provide said UE configuration for MBS to said user equipment (UE).

60. The network or operator apparatus according to claim 59, wherein said UE MBS roaming authorization information comprises:
roaming-related information about whether the UE is allowed or disallowed to access MBS services when roaming.

61. The network or operator apparatus according to claim 60, wherein said roaming-related information relates to or is related to at least one of the following:
an MBS service type, or
the network in which the UE is roaming.

62. The network or operator apparatus according to claim 61, wherein
the MBS service type comprises or relates to multicast and broadcast MBS services, multicast MBS services or broadcast MBS services, and/or
the network in which the UE is roaming comprises a public land mobile network, or one of a standalone non-public network or a public network integrated non-public network.

63. The network or operator apparatus according to claim 61, wherein said roaming-related information identifies or indicates at least one of the following:
the MBS service type, or
the network and/or a type of the network.

64. The network or operator apparatus according to claim 59, wherein said UE MBS roaming authorization information comprises:
network-related information about one or more networks in which the UE is allowed or disallowed to access MBS services when roaming in said one or more networks.

65. The network or operator apparatus according to claim 64, wherein said network-related information identifies or indicates one of:
said one or more networks, or
said one or more networks and an MBS service type.

66. The network or operator apparatus according to claim 65, wherein
the MBS service type comprises or relates to multicast and broadcast MBS services, multicast MBS services or broadcast MBS services.

67. The network or operator apparatus according to claim 59, wherein said UE MBS roaming authorization information comprises:
service-related information about one or more MBS services which the UE is allowed or disallowed to access when roaming.

68. The network or operator network or operator according to claim 67, wherein said service-related information identifies or indicates one of:
said one or more MBS services, or
said one or more MBS services and one or more networks in which the UE is allowed or disallowed to access said one or more MBS services when roaming in said one or more networks.
